(19) United States
(12) Patent Application Publication
(10) Pub. No.: US 2010/0054712 A1
(43) Pub. Date: Mar. 4, 2010

(54) System and Method for Recording High-Definition Content

(75) Inventors: Steven M. Wollmershauser, San Antonio, TX (US); William O. Sprague, JR., Wimberley, TX (US); Jason B. Sprague, San Antonio, TX (US)

Correspondence Address: AT&T Legal Department - LNA;Attn: Patent Docketing, Room 2A- 207, One AT & T Way, Bedminster, NJ, 07921, US

(73) Assignee: AT&T INTELLECTUAL PROPERTY I, L.P., Reno, NV (US)

(21) Appl. No.: 12/201,843

(22) Filed: Aug. 29, 2008

(51) Int. Cl. H04N 5/91; H04N 7/173

(52) U.S. Cl. 386/123; 725/118; 386/E05.003

(57) ABSTRACT

An Internet protocol television system includes a server that delivers high-definition and standard-definition streams to a set-top box, receives a request to record a high-definition stream, records the high-definition stream on the set-top box, receives another request to view a different high-definition stream, and queries the set-top box whether to continue recording in high-definition, or to view the different high-definition stream. a digital video recorder receives high-definition and standard-definition streams, receives a request to record from the high-definition stream, receives another request to view a different high-definition stream queries a user whether to continue recording the high-definition stream or view the different high-definition stream. A method includes delivering high-definition and standard-definition streams to a set-top box, receiving a request to record a high-definition stream, receiving another request to view a different high-definition stream, and querying whether to continue recording the high-definition stream or view the different high-definition stream.

### FIELD OF THE DISCLOSURE

The present disclosure generally relates to communication networks, and more particularly relates to recording high-definition content from a communication network on a digital video recorder.

### BACKGROUND

A digital video recorder (DVR) records television programs for later viewing. The programs may come from a cable, satellite, broadcast or other television source, or from an Internet protocol television (IPTV) network, and are typically in a standard-definition (SD) or high-definition (HD) format. A user selects the program to record, and the program is then stored in a digital format. If the DVR includes more than one tuner, the user may view a program on one channel and simultaneously record a program on a different channel.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) system;

FIG. 2 is a schematic illustration of an embodiment of a set-top box for use in the IPTV system;

FIG. 3 illustrates an embodiment of a channel table, in accordance with an aspect of the present disclosure;

FIG. 4 illustrates an embodiment of an HD option screen depicted on a display device;

FIG. 5 is a schematic illustration of an embodiment of a stand-alone digital video recorder;

FIG. 6 is a flow chart illustrating an embodiment of a method of recording and viewing content on an IPTV system; and

FIG. 7 is a diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

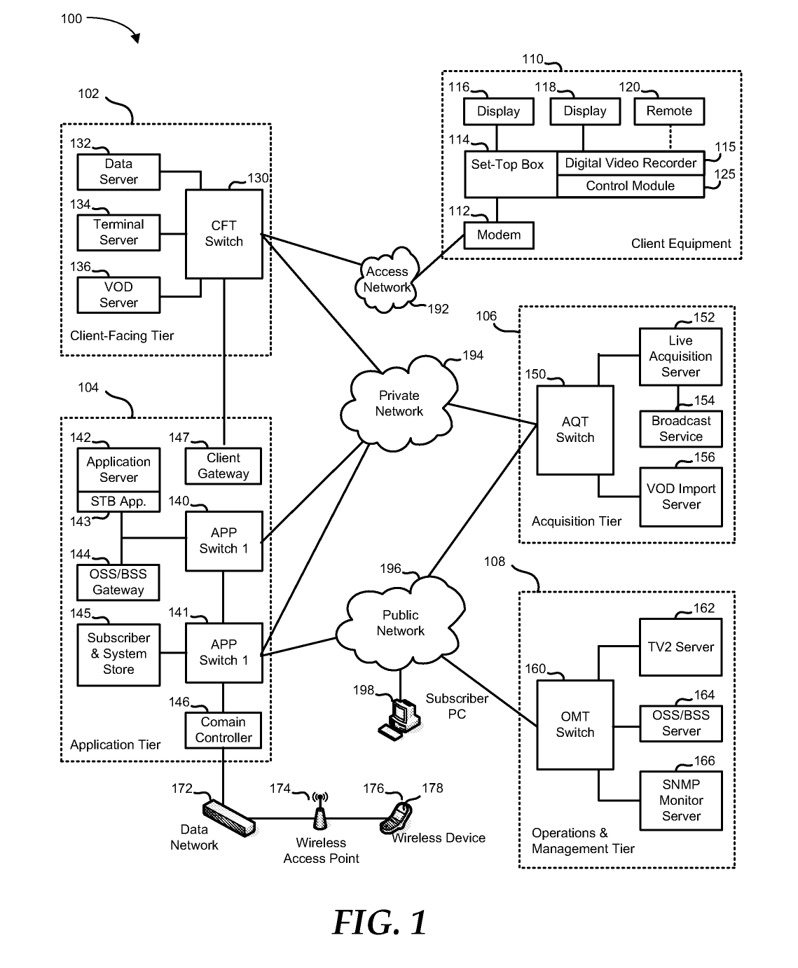

FIG. 1 shows an embodiment of an Internet protocol television (IPTV) system 100 including a client facing (CF) tier 102, an application tier 104, an acquisition tier 106, an operations and management (OM) tier 108, and one or more sets of client equipment 110. The client equipment 110 is typically located at the home or business premises of a subscriber to the IPTV system 100. The IPTV system 100 includes an access network 192, a private network 194, and a public network 196. Each tier 102, 104, 106, and 108 is coupled to one or more of the access network 192, the private network 194, and the public network 196. In an embodiment, the CF tier 102 is coupled to the access network 192 and the private network 194, the application tier 104 is coupled to the private network 194 and to the public network 196, the acquisition tier 106 is coupled to the private network 194 and to the public network 196, and the OM tier 108 is coupled to the public network 196. The client equipment 110 is coupled to the access network 192.

The networks 192, 194 and 196 communicate information between the tiers 102, 104, 106, and 108, and the client equipment 110. The access network 192 communicates information between the CF tier 102 and the client equipment 110. The private network 194 communicates information between the CF tier 102 and the application tier 104, between the application tier 104 and the acquisition tier 106, and between the acquisition tier 106 and the CF tier 102. The public network 196 communicates information between the application tier 104 and the acquisition tier 106, between the acquisition tier 106 and the OM tier 108, and between the OM tier 108 and the application tier 104. Information is also communicated directly between the CF tier 102 and the application tier 104, as described below. The information communicated between the tiers 102, 104, 106, and 108, and the client equipment 110 includes encoded television or audio content, data files, commands, procedures, other information, or any combination thereof.

The CF tier 102 can communicate with multiple sets of client equipment 110 over a wide geographic area, such as a regional area, a metropolitan area, a viewing area, or any other suitable geographic area that can be supported by the access network 192. The client equipment 110 includes a modem 112, a set-top box 114, two display devices 116 and 118, and a remote control 120. The set-top box 114 includes a DVR 115 and a control module 125. The modem 112 is coupled to the access network 192, and translates information from a form suitable for transmission over the access network 192 to a form suitable for use by the set-top box 114, and vice versa. In a non-limiting example, the modem 112 is coupled to the access network 192 via fiber-optic cables, a digital subscriber line (DSL), another network fabric, or any combination thereof.

The information that the CF tier 102 communicates to the modem 112 is sent to the set-top box 114, which processes the information into a form suitable for display by the display devices 116 and 118 or for recording by the DVR 115. The set-top box 114 receives digitally encoded content from the CF tier 102 for display on the display devices 116 and 118, or for recording by the DVR 115. The set-top box 114 can also receive data from the CF tier 102, and render or display the data on the display device 116 or 118. Further, the set-top box 114 can send data to the CF tier 102. Such data can include service requests, or commands from the subscriber, received by the set-top box 112 via the remote control 120. In this way, the subscriber can request services or information or respond to a request for information from the IPTV system 100. The control module 125 includes instructions that can be executed by the set-top box 114 to control the data flow between the subscriber and the IPTV system 100. The control module 125 can include an IPTV software platform such as Microsoft® TV IPTV Edition.

The control module 125 can facilitate data communication between the set-top box 114 and the IPTV system 100. For example, the control module 125 can include a procedure whereby the set-top box 114 receives a request to record a television program on the DVR 115, or sends a status to the IPTV system 100 that the television program has been recorded. Likewise, the control module 125 can include a procedure whereby the subscriber can interact with the IPTV system 100 to receive and execute a viewing preference that the subscriber has created in the IPTV system 100. Such preferences can be created via the remote control 120, or through a subscriber account that is accessible through the public network 196, such as through a subscriber's personal computer 198. A non-limiting example of a remote control 120 includes a hand-held controller device, a game controller device, a keyboard/mouse device, another control device, or any combination thereof.

The CF tier 102 includes a client-facing tier (CFT) switch 130, a data server 132, a terminal server 134, and a video-on-demand (VOD) server 136. The CFT switch 130 manages communication with the client equipment 110 through the access network 192 and with the application tier 104 and the acquisition tier 106 through the private network 194. The CFT switch 130 is coupled to the data servers 132 that store data transmitted in response to subscriber requests. The CFT switch 130 is also coupled to the terminal servers 134 that provide terminal devices, such as, a game application server, or other devices with a common connection point to the private network 194. The CFT switch 130 is also coupled to the VOD server 136.

The application tier 104 includes a first application tier (APP) switch 140, a second application tier (APP) switch 141, an application server 142, an operation systems and support/billing systems and support (OSS/BSS) server 144, a domain controller 146, a subscriber and system store 145, and a client gateway 147. The APP switches 140 and 141 manage communication with the CF tier 102 and the acquisition tier 106 through the private network 194. The APP switch 141 also manages communication with the acquisition tier 106 and the OM tier 108 through the public network 196. The first APP switch 140 is coupled to the second APP switch 141. The first APP switch 140 is also coupled to the application server 142 and to the OSS/BSS gateway 144. The application server 142 provides applications to the set-top box 114, so the set-top box 114 can provide functions such as display, messaging, processing of IPTV data and VOD material. The OSS/BSS gateway 144 includes operation systems and support (OSS) data, and billing systems and support (BSS) data.

The second APP switch 141 is coupled to the domain controller 146 and to the subscriber and system store 145. The domain controller 146 provides web access, for example, to subscribers via the public network 196. The subscriber and system store 148 includes account information that is associated with subscribers who access the IPTV system 100 via the private network 194 or the public network 196. The application tier 104 can also communicate data directly to the CF tier 102 through the client gateway 147. In this embodiment, the client gateway 147 is coupled directly to the CFT switch 130.

The client gateway 147 provides subscriber access to the private network 194 and the tiers coupled thereto. In particular, the set-top box 114 can access the IPTV system 100 via the access network 192 using information received from the client gateway 147. The access network 192 provides security for the private network 194. The client equipment 110 access the client gateway 147 via the access network 192, and the client gateway 147 allows the client equipment 110 to access the private network 194 once the client equipment 110 is authenticated or verified. Similarly, the client gateway 147 prevents unauthorized client equipment (not illustrated), such as hacker computers or stolen set-top box devices, from accessing the private network 194 by denying access to these devices beyond the access network 192.

For example, when the set-top box device 114 accesses the system 100 via the access network 192, the client gateway 147 verifies subscriber information by communicating with the subscriber and system store 145 via the private network 194, the first APP switch 140, and the second APP switch 141. Further, the client gateway 147 verifies billing information and status by communicating with the OSS/BSS gateway 144 via the private network 194 and the first APP switch 140. The OSS/BSS gateway 144 transmits a query across the first APP switch 140, to the second APP switch 141, and the second APP switch 141 communicates the query across the public network 196 to an OSS/BSS server 164 (described below). After the client gateway 147 confirms subscriber and/or billing information, the client gateway 147 allows the set-top box device 114 access to IPTV system 100 content and VOD server 136 content. If the client gateway 147 cannot verify subscriber information for the set-top box 114, such as when the set-top box 114 is connected to a different twisted pair, or when the set-top box 114 is stolen, the client gateway 147 denies transmissions to and from the set-top box device 114 beyond the access network 192.

The domain controller 146 communicates with the public network 196 via the second APP switch 141. The domain controller can include a web portal that allows a subscriber to access the IPTV system 100 using a personal computer 198. The domain controller 146 also communicates with a data network 172 that is connected to a wireless access point 174. The wireless access point 174 communicates with a subscriber's wireless device 176 to provide wireless access to the IPTV system 100. A non-limiting example of a wireless device 176 includes a cellular telephone, a personal digital assistant, a mobile e-mail device, a portable digital video device, another wireless device, or any combination thereof. The wireless device 176 includes a display device 178 for displaying information from the IPTV system 100. The display device 178 can include a text display, a picture display, a video display or any combination thereof.

The acquisition tier 106 includes an acquisition tier (AQT) switch 150, a live acquisition server 152, a broadcast service 154, and a video-on-demand importer server 156. The AQT switch 150 manages communication with the CF tier 104 and the application tier 104 through the private network 194, and with the application tier 104 and the OM tier 108 through the public network 196. The AQT switch 150 is coupled to the live acquisition server 152, and the video-on-demand importer server 156. The live acquisition server 152 acquires television content from the broadcast service 154. The live acquisition server 152 can send the television content to the AQT switch 150 for transmission to the CF tier 102 via the private network 194. The television content is further encoded at the data server 132, and sent to the client equipment 110 via the access network 192. The set-top box 114 receives the television content from the modem 112, decodes the television content, and transmits the content to the display devices 116 and 118 according to commands from the remote control device 120.

Additionally, the VOD importer server 156 receives content from one or more video-on-demand sources that can be outside the IPTV system 100, such as movie studios and programmers of non-live content. The VOD importer server 156 transmits the video-on-demand content to the AQT switch 150, and the AQT switch 150 communicates the material to the CFT switch 130 via the private network 194. The video-on-demand content is stored on the VOD server 136. When a subscriber issues a request for VOD content to the set-top box 114 through the remote control 120, the request is transmitted over the access network 192 to the VOD server 136 via the CFT switch 130. Upon receiving such a request, the VOD server 136 can retrieve requested VOD content and transmit the content to the set-top box or 114 across the access network 192 via the CFT switch 130.

The OM tier 108 includes an OM tier (OMT) switch 160, a TV2 server 162, the OSS/BSS server 164, and a simple network management protocol (SNMP) monitor server 166. The OMT switch 160 manages the communication between the OM tier 108 and the public network 196. The OMT switch 160 is coupled to the TV2 server 162, the OSS/BSS server 164, and the SNMP monitor server 166 that monitors network devices. The TV2 server 162 receives television content from the live acquisition server 152, or video-on-demand content from the VOD importer server 156 through the public network 196. The television and video-on-demand content can be sent by the TV2 server 162 to the OMT switch 160 and forwarded to a subscriber of the IPTV system 100 who accesses the public network 196 through the personal computer 198.

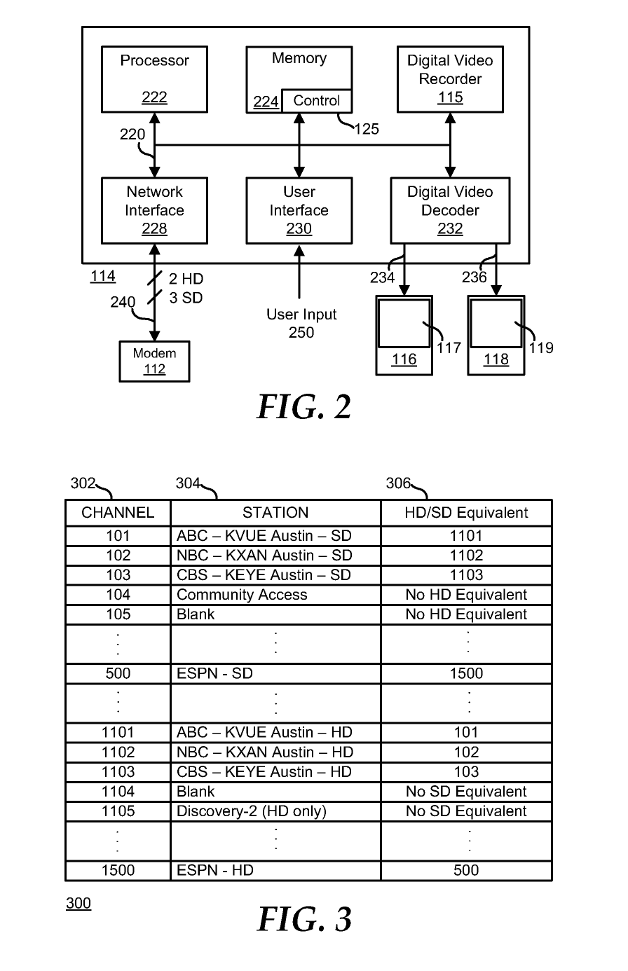

FIG. 2 is a schematic illustration of an embodiment of the set-top box 114. The set-top box 114 includes the DVR 115, a processor 222, a memory 224, a network interface 228, a user interface 230, and a digital video decoder 232. As illustrated, the control module 125 is preferably implemented as processor executable code in the memory 224. The network interface 228 receives a digital input 240 from the modem 112, and communicates with a bus 220. The processor 222, the memory 224, the DVR 115, the user interface 230, and the digital video decoder 232 are also coupled to the bus 220. The user interface 230 receives a user input 250. The digital video decoder 232 includes two outputs 234 and 236 that are coupled to the display devices 116 and 118, respectively. The DVR 115 can include a storage device, such as a hard drive, a non-volatile memory device, another storage device, or any combination thereof. The display devices 116 and 118 include a screen 117 and 119, respectively. A non-limiting example of a user interface 230 includes a keypad or touch panel included in the set-top box 114, a wireless interface for use with the remote control 120, another user interface, or any combination thereof.

The set-top box 114 exchanges information with the IPTV system 100 via the network interface 228, displays content from the digital input 240 on the display devices 116 and 118, and records content on the DVR 115. The digital input 240 includes digital information streams containing the content of various channels. The content on a digital information stream can be in a standard-definition (SD) format, or in a high-definition (HD) format. In an embodiment, the digital input 240 includes two digital information streams that are HD formatted, and three digital information streams that are SD formatted. Based upon the user input 250, the set-top box 114 communicates with the IPTV system 100 to request the content from various SD channels and HD channels. Under the control of the processor 222 and the control module 125, the digital information streams are directed to the DVR 115 and/or to the digital video decoder 232 for display on the display devices 116 and 118. The digital information streams stored on the DVR 115 can also be directed to the digital video decoder 232 for display on the display devices 116 and 118.

A user interacts with the set-top box 114 by providing user input 250 to the user interface 230. Under the control of the processor 222 and the control module 125, the user can choose to view selected content from the digital input 240 or from the DVR 115 on the display devices 116 and 118, or to record selected content from the digital input 240 on the DVR 115. The control module 125 typically presents the user with options for viewing and recording through option menus depicted on the screens 117 and 119, and receives the user input 250 through the user interface 230.

The control module 125 can implement a channel table that lists the television channels that are available on the digital signal 240. FIG. 3 illustrates an embodiment of a channel table 300. The channel table 300 includes a channel list 302, a station list 304, and an equivalent channel list 306. The channel list 302 contains an entry for each of the available channels, whether they originated from a terrestrial broadcast, cable television, satellite television, or otherwise. The station list 304 contains station information for the content providers associated with each channel. Content that is available on one channel in an SD format can also be available on another channel in an HD format, and vice versa. The equivalent channel list 306 includes an entry for each SD channel that indicates if there is an HD channel that contains the same content, and if so, indicates the HD channel number. The equivalent channel list 306 likewise includes an entry for each HD channel that indicates if there is an SD channel that contains the same content, and if so, indicates the SD channel number.

For an enhanced user experience, the user can select to view or record content from the HD streams of the digital input 240. For example, a first user can choose to view HD content from a first channel on the display device 116 via a first HD stream, and a second user can choose to view HD content from a second channel on the display device 118 via a second HD stream. Typically, the content from each HD stream can also be recorded by the DVR 115 at substantially the same time as the content is being viewed. However, because there are three possible destinations for HD content (e.g., the DVR 115, and the display devices 116 and 118), and only two HD streams, conflicts can arise when a user desires to view HD content from the first and second channels on the display devices 116 and 118, and also to record HD content from a third channel at the same time.

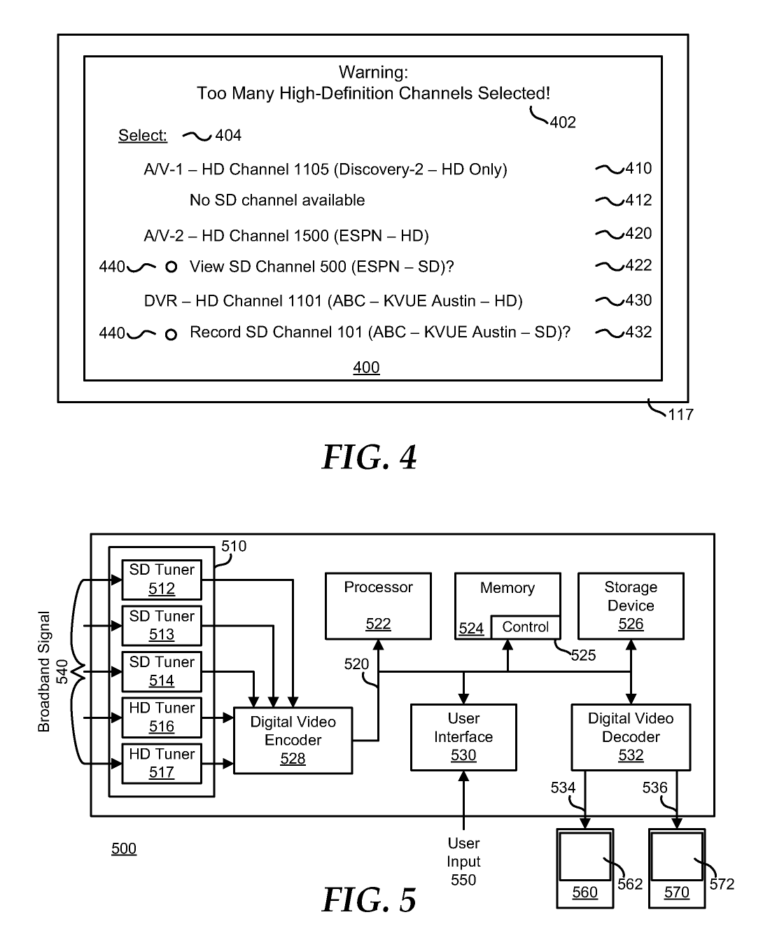

In an embodiment of the present disclosure, when a user places a request to obtain content from a third HD channel, the control module 125 presents the user with options for selecting one of the three requested HD channels, replacing the selected HD channel with an associated SD channel carrying the same content, and displaying or recording the associated SD channel instead of the selected HD channel. FIG. 4 illustrates an embodiment of an HD option screen 400 depicted on, for example, the screen 117. The HD option screen 400 includes a warning banner 402, an instruction banner 404, three HD channel request banners 410, 420, and 430, and three SD channel selection options 412, 422, and 432.

The warning banner 402 presents a message that the HD channel requests exceed the available HD channel capacity. The instruction banner 404 prompts the user to select an option for replacing one of the HD channel requests with an SD channel request. The HD channel request banners 410, 420, and 430 indicate which HD channels have been requested for direction to the display devices 116 and 118, and to the DVR 115, respectively. The SD channel selection options 412, 422, and 432 list the SD channel that contains the same content as the HD channel indicated in the associated HD channel request banners 410, 420, and 430, and permit the user to select which SD channel to view or record in the place of the requested HD channel. The SD channels listed in the SD channel selection options 412, 422, and 432 can be determined from the equivalent channel list 306 in the channel table 300. The SD selection options 412, 422, or 432 indicate that a requested HD channel has an equivalent SD channel with a selection bubble 440. An SD selection option 412, 422, or 432 that does not include a selection bubble 440 indicates that the requested HD channel does not have an equivalent SD channel. The user provides a user input 250, selecting one of the available selection bubbles 440 to indicate to the control module 125 which HD channel request to replace.

In the example illustrated in FIGS. 3 and 4, the user has requested to view HD content, described as “HD Channel 1102 (Discovery-2—HD only)” on the display device 116. The channel table 300 reveals that there is no SD equivalent channel for HD channel 1105 where the equivalent channel list 306 notes “No SD Equivalent” in the entry associated with channel 1105 in the channel list 302. Therefore, the SD channel selection option 412 has no selection bubble 440, and reads “No SD channel available.” The user has also requested to view HD content, described as “HD Channel 1500 (ESPN—HD)” on the display device 118. The channel table 300 reveals that channel 500 is the SD equivalent channel for HD channel 1500. Therefore, the SD channel selection option 422 has a selection bubble 440, and reads “View SD Channel 500 (ESPN—SD)?” The user has also requested to record HD content, described as “HD Channel 1101 (ABC—KVUE Austin—HD)” on the DVR 115. The channel table 300 reveals that channel 101 is the SD equivalent channel for HD channel 1101. Therefore, the SD channel selection option 432 has a selection bubble 440, and reads “Record SD Channel 101 (ABC—KVUE Austin—SD)?” In this example, the user may select to view SD content on the display device 118, leaving the requested recording of HD content on the DVR 115 unchanged, or vice versa. In another embodiment, the control module 125 presents the HD option screen 400 for a limited time. If, in that time, the user has made no selection, the control module 125 makes a selection. For example, the control module 125 can prioritize the requested recording of HD content on the DVR 115 over the requested viewing of HD on the display device 118, or vice versa.

In another embodiment of the present disclosure, the channel selection, viewing and recording on the set-top box 114 can be under the control of a set-top box application 143 in the application server 142. Here, a user interacts with the set-top box 114 by providing user input 250 to the user interface 230 to choose to view or record selected content, and the user input 250 is communicated from the set-top box 114 to the set-top box application 143. The set-top box application 143 communicates with the set-top box 114 to present the user with options for viewing and recording, and implements a channel table similar to the channel table 300. When the user places a request to view or record a third HD channel, the set-top box 114 communicates the request to the set-top box application 143 which directs the set-top box 114 to present the user with an HD option screen similar to the HD option screen 400, and the user provides a user input 250, selecting one of the available selection bubbles 440 to indicate to the set-top box application 143 which HD channel request to replace. In another embodiment, the set-top box application 143 presents the HD option screen 400 for a limited time. If, in that time, the user has made no selection, the set-top box application 143 makes a selection. For example, the set-top box application 143 can prioritize the requested recording of HD content on the DVR 115 over the requested viewing of HD on the display device 118, or vice versa.

In a further embodiment of the present disclosure, a stand-alone DVR can be connected to a broadband signal source, such as a terrestrial signal obtained from an aerial antenna or satellite downlink, a cable television service, another broadband signal, or any combination thereof. FIG. 5 shows an embodiment of a stand-alone DVR 500. The stand-alone DVR 500 includes a receiver 510, a processor 522, a memory 524, a storage device 526, a digital video encoder 528, a user interface 530, and a digital video decoder 532. As illustrated, the memory 524 includes a control module 525 that functions similarly to the control module 125, and may preferably be implemented as processor executable code. The storage device 526 can include a hard drive, a non-volatile memory device, another storage device, or any combination thereof.

The receiver 510 includes three SD tuners 512, 513, and 514, and two HD tuners 516 and 517. The digital video encoder 528 receives an input from each tuner 512, 513, 514, 516, and 517, and sends an output to a bus 520. The processor 522, the memory 524, the storage device 526, the user interface 530, and the digital video decoder 532 are also coupled to the bus 520. The tuners 512, 513, 514, 516, and 517 receive a broadband signal 540. The user interface 530 receives a user input 550. The digital video decoder 532 includes two outputs 534 and 536 that are coupled to display devices 560 and 570, respectively. The display devices 560 and 570 each include a screen 562 and 572, respectively.

The stand-alone DVR 500 receives the broadband signal 540 at the receiver 510, tunes to a desired channel, and either displays or records the content presented on the channel. The broadband signal 540 includes signals that are modulated onto the various channels. The content on a channel can be in SD or HD format. The tuners 512, 513, 514, 516, and 517 each tune in one selected channel. The tuners 512, 513, 514, 516, and 517 also demodulate the content from the channel and output the demodulated content to the digital video encoder 528. The HD tuners 516 and 517 can tune into channels presenting either HD formatted content or SD formatted content, demodulate the HD formatted content into an HD output, and demodulate SD formatted content into an SD output. However, the SD tuners 512, 513, and 514 can only demodulate content into an SD output, regardless of whether the channel presents HD formatted content or SD formatted content.

The digital video encoder 528 receives the demodulated signals and converts them into digital data. Under the control of the processor 522 and the control module 525 in the memory 524, the digital data can be directed to the storage device 526 or to the digital video decoder 532 to be converted to signals suitable for display on the display devices 560 and 570. Likewise, digital data stored on the storage device 526 can be directed to the digital video decoder 532 for display on the display devices 560 and 570. In another embodiment (not illustrated), the signals from the tuners 512, 513, 514, 516 and 517 can be switched to the outputs 534 and 536 for display on the display devices 560 and 570, without passing through the digital video encoder 528 and the digital video decoder 532, but the digital video encoder 528 still converts the signals into digital content for recording.

A user interacts with the stand-alone DVR 500 by providing user input 550 to the user interface 530. Under the control of the processor 522 and the control module 525, the user can choose to view selected content from the broadband signal 540 or the storage device 526 on the display devices 560 and 570, or to record selected content from the broadband signal 540 on the storage device 526. The control module 525 presents the user with options for viewing and recording, receives the user input 550 through the user interface 530, and implements a channel table similar to the channel table 300. Here, when the user places a request to view or record a third HD channel, the control module 525 presents the user with an HD option screen similar to the HD option screen 400, and the user provides a user input 550, selecting one of the available selection bubbles 440 to indicate to the control module 525 which HD channel request to replace. In another embodiment, the control module 525 presents the HD option screen 400 for a limited time. If, in that time, the user has made no selection, the control module 525 makes a selection. For example, the control module 525 can prioritize the requested recording of HD content on the DVR 115 over the requested viewing of HD on the display device 118, or vice versa.

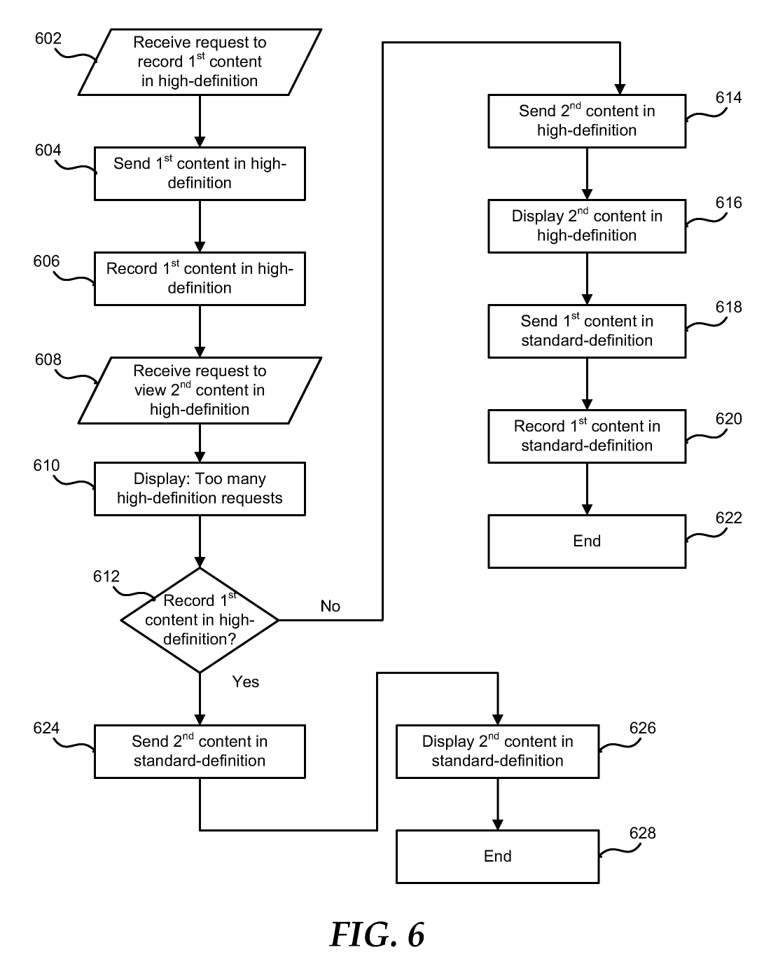

FIG. 6 illustrates an embodiment of a method of recording and viewing content on an IPTV system 100 with a set-top box 114 in a flow chart form. The IPTV system 100 receives a request from the set-top box 114 to record a first content from a first HD channel in block 602. The IPTV system 100 sends the first content in an HD format to the set-top box 114 in block 604. The set-top box 114 records the first content to the DVR 115 in block 606. The IPTV system 100 receives a request from the set-top box 114 to view a second content from a second HD channel in block 608. The IPTV system 100 sends a message to the set-top box 114 that the number of HD requests exceeds a threshold, such as the available bandwidth, and the set-top box 114 displays the message to the user in block 610. A decision is made whether the user desires to continue recording the first content in an HD format, or view the second content in an HD format in decision tree 612. If the user desires to continue recording the first content in an HD format, then the IPTV system 100 sends the second content in an SD format in block 624, the set-top box 114 displays the second content in an SD format on one of the display devices 116 or 118 in block 626, and processing ends in block 628.

If the user desires to view the second content in an HD format in decision tree 612, then the IPTV system 100 sends the second content in an HD format in block 614. The set-top box 114 displays the second content in an HD format on one of the display devices 116 or 118 in block 616. The IPTV system 100 sends the first content in an SD format in block 618, the set-top box 114 records the first content in an SD format on the DVR 115 in block 620, and processing ends in block 622. In a different embodiment (not illustrated), the method of FIG. 6 is adapted to a DVR such as the stand-alone DVR 500.

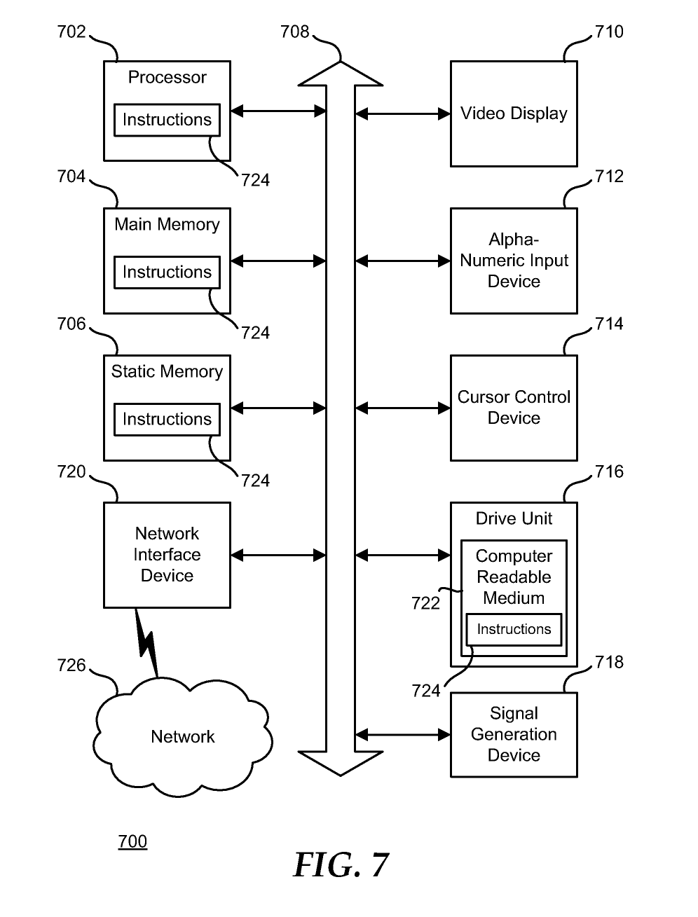

FIG. 7 shows an illustrative embodiment of a general computer system 700 in accordance with at least one embodiment of the present disclosure. The computer system 700 can include a set of instructions that can be executed to cause the computer system 700 to perform any one or more of the methods or computer based functions disclosed herein. The computer system 700 may operate as a standalone device or may be connected via a network to other computer systems or peripheral devices.

In a networked deployment, the computer system may operate in the capacity of a server or as a client computer in a server-client network environment, or as a peer computer system in a peer-to-peer (or distributed) network environment. The computer system 700 can also be implemented as or incorporated into various devices, such as a personal computer (PC), a tablet PC, a set-top box, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

The computer system 700 may include a processor 702 such as a central processing unit (CPU), a graphics processing unit (GPU), or both. Moreover, the computer system 700 can include a main memory 704 and a static memory 706 that can communicate with each other via a bus 708. As shown, the computer system 700 may further include a video display device 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, the disk drive unit 716 may include a computer-readable medium 722 in which one or more sets of instructions 724 can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media. The network interface device 720 can provide connectivity to a network 726 such as a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. An Internet protocol television (IPTV) system comprising a server operable to:
deliver a high-definition stream and a standard-definition stream to a set-top box;
receive a first request from the set-top box to send a first channel from the high-definition stream to the set-top box for recording;
in response to the first request, send the first channel from the high-definition stream to the set-top box for recording;
while the first channel is being recorded, receive a second request from the set-top box to send a second channel from the high-definition stream to the set-top box for viewing; and
send a query to the set-top box to select whether to:
continue recording the first channel from the high-definition stream and view the second channel from the standard-definition stream, or
view the second channel from the high-definition stream and continue recording the first channel from the standard-definition stream.

2. The IPTV system of claim 1 wherein the server is further operable to:
in response to sending the query to the set-top box, receive a third request from the set-top box to continue recording the first channel from the high-definition stream and to view the second channel from the standard-definition stream; and
in response to the third request, send the second channel from the standard-definition stream to the set-top box for viewing.

3. The IPTV system of claim 2 wherein the server is further operable to:
in response to sending the query to the set-top box, receive a fourth request from the set-top box to view the second channel from the high-definition stream and to continue recording the first channel from the standard-definition stream; and
in response to the fourth request:
send the first channel from the standard-definition stream to the set-top box for recording; and
send the second channel from the high-definition stream to the set-top box for viewing.

4. The IPTV system of claim 3 wherein a first set of viewable channels on the standard-definition stream includes content that is also available to be viewed on a second set of viewable channels on the high-definition stream.

5. The IPTV system of claim 4 further comprising a table that correlates each of a first particular channel from among the first set of viewable channels with an associated second particular channel from among the second set of viewable channels that includes the same content as the first particular channel.

6. The IPTV system of claim 5 wherein the server is further operable to:
in response to the third request and the fourth request, determine the second channel from the table that is associated with the first channel.

7. The IPTV system of claim 3 wherein the set-top box is operable to send the first request, the second request, the third request, and the fourth request in response to a user input.

8. A digital video recorder operable to:
receive a high-definition stream and a standard-definition stream;
receive a first user request to record a first channel from the high-definition stream;
record the first channel;
while the first channel is being recorded, receive a second user request to view a second channel from the high-definition stream; and
display a query to a user to select whether to:
continue recording the first channel from the high-definition stream and view the second channel from the standard-definition stream, or
view the second channel from the high-definition stream, and continue recording the first channel from the standard-definition stream.

9. The digital video recorder of claim 8 further operable to:
in response to displaying the query, receive a third user request to continue recording the first channel from the high-definition stream, and to view the second channel from the standard-definition stream;
in response to the third user request, display the second channel from the standard-definition stream; and

10. The digital video recorder of claim 9 further operable to:
in response to displaying the query, receive a fourth user request to display the second channel from the high-definition stream, and to continue recording the first channel from the standard-definition stream; and
in response to the fourth user request:
record the first channel from the standard-definition stream; and
display the second channel from the high-definition stream.

11. The digital video recorder of claim 10 wherein a first set of viewable channels on the standard-definition stream includes content that is also available to be viewed on a second set of viewable channels on the high-definition stream.

12. The digital video recorder of claim 11, comprising a table that correlates each of a first particular channel from among the first set of viewable channels with an associated second particular channel from among the second set of viewable channels that includes the same content as the first particular channel.

13. The digital video recorder of claim 12 further operable to:
in response to the third user request and the fourth user request, determine the second channel from the table that is associated with the first channel.

14. The digital video recorder of claim 10 wherein the digital video recorder is operable to send the first request, the second request, the third request, and the fourth request in response to a user input.

15. A method comprising:
delivering a high-definition stream and a standard-definition stream to a set-top box;
receiving a first request from the set-top box to send a first channel from the high-definition stream to the set-top box for recording;
in response to the first request, sending the first channel from the high-definition stream to the set-top box for recording;
while the first channel is being recorded, receiving a second request from the set-top box to send a second channel from the high-definition stream to the set-top box for viewing; and
sending a query to the set-top box to select whether to:
continue recording the first channel from the high-definition stream, and view the second channel from the standard-definition stream, or
view the second channel from the high-definition stream, and continue recording the first channel from the standard-definition stream.

16. The method of claim 15 further comprising:
in response to sending the query to the set-top box, receiving a third request from the set-top box to continue recording the first channel from the high-definition stream, and to view the second channel from the standard-definition stream; and
in response to the third request, sending the second channel from the standard-definition stream to the set-top box for viewing.

17. The method of claim 16 further comprising:
in response to sending the query to the set-top box, receiving a fourth request from the set-top box to view the second channel from the high-definition stream, and to continue recording the first channel from the standard-definition stream; and
in response to the fourth request:
sending the first channel from the standard-definition stream to the set-top box for recording; and
sending the second channel from the high-definition stream to the set-top box for viewing.

18. The method of claim 17 wherein a first set of viewable channels on the standard-definition stream includes content that is also available to be viewed on a second set of viewable channels on the high-definition stream.

19. The method of claim 18 further comprising creating a table that correlates each of a first particular channel from among the first set of viewable channels with an associated second particular channel from among the second set of viewable channels that includes the same content as the first particular channel.

20. The method of claim 19 further comprising:
in response to the third request and the fourth request, determining the second channel from the table that is associated with the first channel.

21. The method of claim 17 wherein receiving the first request, the second request, the third request, and the fourth request are in response to receiving a user input.
